(19) United States
(12) Patent Application Publication
(10) Pub. No.: US 2025/0078122 A1
(43) Pub. Date: Mar. 6, 2025

(54) REAL ESTATE GRADING SYSTEM AND METHOD

(71) Applicant: That David, LLC, Austin, TX (US)

(72) Inventor: David Alan White, Austin, TX (US)

(73) Assignee: That David, LLC, Austin, TX (US)

(21) Appl. No.: 18/239,983

(22) Filed: Aug. 30, 2023

Related U.S. Application Data
(60) Provisional application No. 63/535,198, filed on Aug. 29, 2023.

(51) Int. Cl. G06Q 30/02; G06Q 50/16

(52) U.S. Cl. CPC G06Q 30/0278; G06Q 50/16

(57) ABSTRACT

A system operable via communications over a digital data network. The system includes a user computer communicatively connected to the digital data network. The user computer includes a processor, memory, and an input device. The system also includes an app program of the user computer stored in the memory for controlling the processor, a server computer communicatively connected to the digital data network, and a database of real property identities and weightage values communicatively connected to the server computer. The app program receives an input and communicates the input to the server computer, the server computer searches the database and calculates a respective score for each of the real property identities corresponding to the input, sends to the computer the real property identities and each of the respective score. The weightage values may but need not necessarily relate to personality types of dominant, compliant, influencing and steady.

### TECHNICAL FIELD

The invention generally relates to analyzers of real estate, and more particularly relates to devices and processes for assessing and grading real estate.

### BACKGROUND

Real estate for sale is conventionally assessed and analyzed based on price, location and square footage. Granular determinants, such as particular features of the property, have not been readily comparable and so not given credits or debits of value. Because of limitations of conventional assessment and analyses, many factors affecting value are never considered or given weight.

Conventional assessment tools have been limited to primarily Internet catalog listings, such as Multiple Listing Service (MLS). These catalog listings have provided some detail of particular properties, such as identities of rooms, structures, location, square footage and price. The listings, however, are just that, and provide no mechanisms for comparison and ranking of properties based on more granular criterion.

It would, therefore, be a significant improvement in the art and technology to provide computer and network communications for grading real properties for comparison.

### SUMMARY

An embodiment of the invention includes a method of scoring real properties. The method includes providing a database of real property identities and weightage values for groups, categories and features of the real property identities, receiving a request by a server computer communicatively connected to the database, from an app of a user computer via a digital data network communicatively connected to the server computer, retrieving real property identities and weightage values responsive to the request by the server computer, calculating by the server computer a respective score for each of the real property identities and weightage values from retrieving, and communicating the respective score for each of the real property identities and weightage values, to the app of the user computer over the digital data network.

Another embodiment of the invention includes a method of scoring real properties. The method includes storing an app program in a computer communicatively connected to a digital data network, processing the app program by the computer, receiving an input to the computer representing a request for real property identities and scores for the real property identities, communicating the input by the computer over the digital data network to a server computer, receiving a response from the server computer over the digital data network, by the computer, the response includes real property identities and score for each of the real property identities, and displaying the real property identities and scores in a display of the computer.

Yet another embodiment of the invention is a system operable via communications over a digital data network. The system includes a user computer communicatively connected to the digital data network, the user computer includes a processor, memory, and an input device, an app program of the user computer stored in the memory for controlling the processor, a server computer communicatively connected to the digital data network, and a database of real property identities and weightage values communicatively connected to the server computer. The app program receives an input and communicates the input to the server computer, the server computer searches the database and calculates a respective score for each of the real property identities corresponding to the input, sends to the computer the real property identities and each of the respective score.

Yet another embodiment of the invention includes a system. The system includes a processor and memory communicatively connected to the processor. The memory contains instructions for controlling the processor for communicating over a digital data network communicatively connected to the processor, processing an input interface output by the processor, receiving an input to the input interface representing a request for real property identities and scores for the real property identities, communicating the input by the processor over the digital data network to a server computer, receiving a response over the digital data network, by the processor, the response includes real property identities and score for each of the real property identities, and outputting the real property identities and scores by the processor.

Another embodiment of the invention includes a system. The system includes a processor, memory communicatively connected to the processor, and a database of real property identities and weightage values for groups, categories and features, communicatively connected to the processor. The memory includes instructions for controlling the processor for receiving a request over a digital data network communicatively connected to the processor, retrieving from the database real property identities and weightage values responsive to the request, calculating a respective score for each of the real property identities and weightage values, and communicating the respective score for each of the real property identities and weightage values, over the digital data network.

### BRIEF DESCRIPTION OF THE DRAWINGS

The present invention is illustrated by way of example and not limitation in the accompanying figures, in which like references indicate similar elements, and in which:

FIG. 1 illustrates a system for ranking real properties according to weighted values and score calculation, according to certain embodiments of the invention;

FIG. 2 illustrates a database schema for storing real properties identities and according weightage values to groups, categories and features, according to certain embodiments of the invention;

FIG. 3 illustrates a method of operating a server computer and database of properties and weighted values to obtain scores for real properties, according to certain embodiments of the invention; and

FIG. 4 illustrates a method of operating a user computer and app of the computer to obtain scores for real properties, according to certain embodiments of the invention.

### DETAILED DESCRIPTION

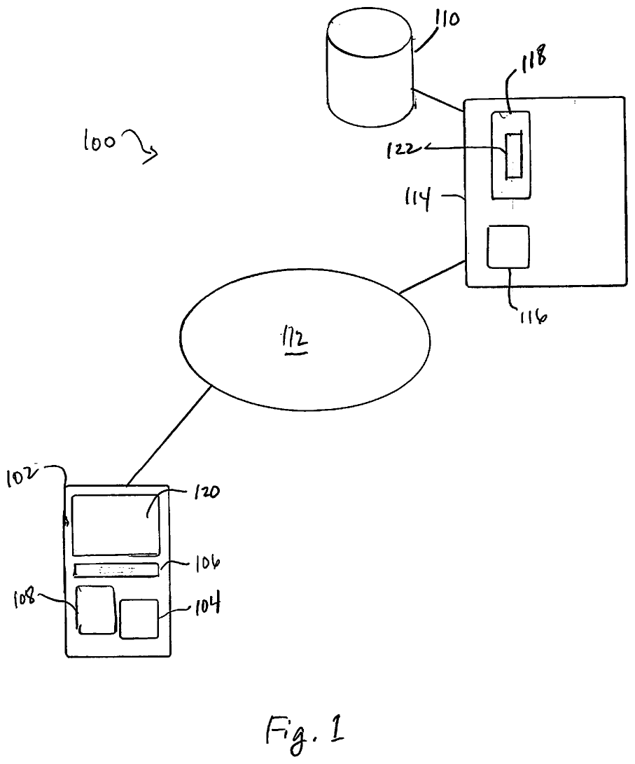

Referring to FIG. 1, according to certain embodiments, in a computer network system 100, an application (for non-exclusive example, a “Property G Score” app) operates in conjunction with a multiple listing service (MLS) catalog or other source of real property identities. A computer 102, such as for non-exclusive example a smart cell phone, tablet, laptop or desktop computer, of the system 100 includes a processor 104 communicatively connected to memory 106. The computer 102 also includes or communicatively connects to a display 118. An application unit 108 is stored in the memory 106. The application unit 108 is communicatively connected to a digital data network 112.

The network 112 is any one or more of a wide variety of communicative link, for example, wire, cable, wireless, optic fiber, cellular, wide area network (WAN), local area network (LAN), wireless local area network (WLAN), satellite or other communicative link now or hereafter available, or combinations of any of these. In certain nonexclusive embodiments, the network 112 is the Internet.

A server computer 114 communicatively connects to the network 112. The server computer 114 includes a server processor 116 and server memory 118. The server computer 114 communicatively connects to a database 110. The database 110 is controlled by the processor 116, as directed by the application unit 108 through communications over the network 112 between the computer 102 and the server computer 114. The application unit 108 allows for input of instructions for communicatively over the network 112 directing the processor 116 to provide the computer 102 with a grading system for real properties through an interface on the display 120 of the computer 102. The server computer 114 includes instructions 122 in the memory 118. The instructions 122 control the processor 116 to operate the database 110 and, responsive to the application unit 108, deliver to the computer 102 responses of the grading system.

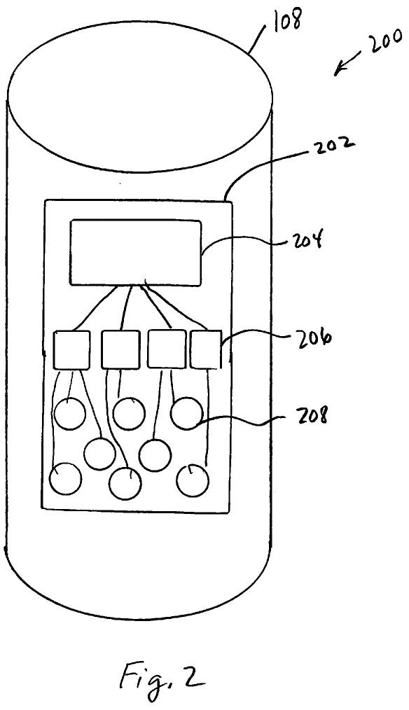

Referring to FIGS. 1 and 2, in conjunction, a store system 200 includes the database 108. The database 108 includes a unique schema 202. The schema 202 includes groups 204, within each group 204 are categories 206, and within each category 206 are features 208. The groups 204, categories 206 and features 208 are related to a real estate listing, such as an MLS or other identification of the real estate.

In certain nonexclusive embodiments, the groups 204 include Design, Outdoor and Lot scores. Each group 204, respectively, includes relevant ones of the categories 206, such as “attached structure” for each group 204. Each category 206, respectively, includes relevant ones of the features 208, such as “lot size” for each category 206. A respective value from one to eight is accorded each group 204, category 206, and feature 208, respectively, for each real estate property of interest. The respective value can be set by the computer 102, the server computer 114, and/or one or more third processing device (not shown in FIGS. 1 and 2) communicatively connected to the network 112.

Based on input to the computer 102, the server computer 114 operates the database 110 to query and retrieve scores based on the respective values for selected real estate propert(ies) of interest of the groups 204, the categories 206 and the features 208. The server computer 114 calculates the score as a weighted determination. The calculation includes a set of predefined criteria and weightage parameters to evaluate and rank properties. The calculation takes into account various factors such as location desirability, infrastructure, proximity to amenities, property condition, historical sales data, market trends, and other relevant data points consistent with the schema 202. Each factor is assigned a specific weightage based on its relative importance in the overall property evaluation process.

Weighting of the values accorded the factors can vary. However, in certain nonexclusive embodiments, the weighting may but need not necessarily be determined based on personality factors of the potential buyer. For example, personality types of potential buyers may be considered to have any of four characteristics: dominant, compliant, influencing, and steadiness personalities. In the example, dominant personality may weight property location more heavily than certain other factors; compliant personality may weight property presentation, such as newer build or features, more heavily; influence personality may weight design of property more heavily; and steady personality may weight more heavily factors such as traditional or timeless design trends. Of course, wide variation in the factors and weighting can be employed based on the region of interest of properties, the pool of potential buyers, and other parameters.

The instructions 122 control the processor 116 to calculate a respective score (a “G score”) for each real property identified in the database 110. The processor 116, responsive to the application unit 108 of the computer 102 via communications over the network, delivers ranked property listings as outputs based on the scores (for nonexclusive example, the “Property G Score”). Property details and other measures available in the database 110 may also be delivered to the application unit 108, as desired in the embodiment.

In operation, property listings and details are entered into the database 110, such as via an input device communicatively connected to the server computer 114 or the database 110. The application unit 108 of the computer 102 communicates over the network 112 to the server computer 114 with a request. The processor 116 of the server computer 114 controls the database 110 based on the request, to obtain property listings, calculate scores, and deliver listings and scores. The server computer 114 communicates over the network 114 to the application unit 108 the listings and scores, in ranked order (e.g., Property G Scores). At the computer 102, the application unit 108 operated by the processor 104 in conjunction with the memory 106, displays on the display 120 the listings and scores.

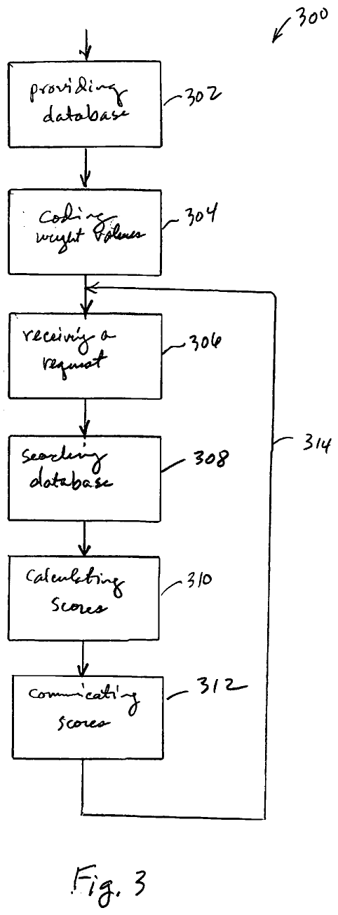

Referring to FIG. 3, a method 300 of operation of a server computer and database in a property grading system includes providing a database 302 of property listings and values for groups, categories, and features. The values are coded 304 in the database for the groups, categories, and features. The server computer receives a request 306 from a user computer via a communications network communicatively connecting the server computer and the user computer. Responsive to receiving the request 306, the server computer searches the database 308 and obtains a result set of properties of the database. The server computer calculates scores 310 (e.g., Property G Scores) for properties of the database obtained in the result set. The server computer communicates the scores 312 and property listings over the network to the user computer. Thereafter, the method returns 314 to receiving request(s).

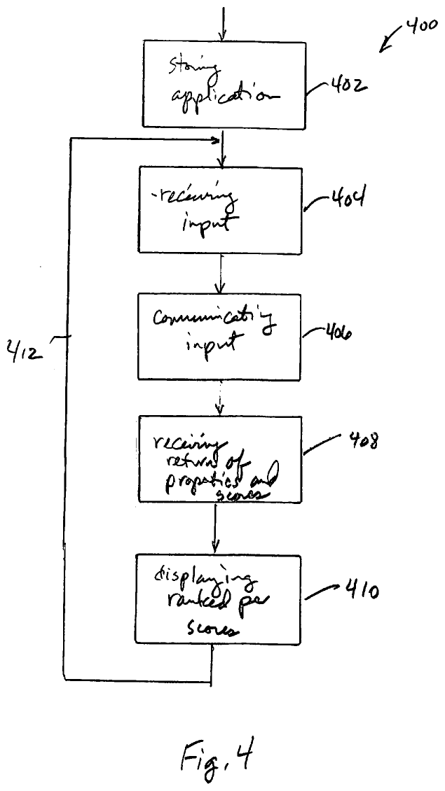

Referring to FIG. 4, a method 400 of operation of a user computer includes storing an application unit 402 for obtaining property listings and scores. The application unit may be, for nonexclusive example, an app program stored in memory of the user device for controlling a processor of the user device to receive the property listings and scores. The user computer receives an input 404 of a request for property listings and scores via an input device, such as for nonexclusive example, a touch display, keyboard, mouse or other device, of the user computer.

The received input is communicated 406 via a communications network to a server computer operating a score calculation program in connection with a property and values database. Responsive to communicating 406, properties listings and scores are received in return 408 by the user computer over the network. The user computer displays 410 the ranked properties in a display of the user computer. The method 400 then returns to receiving input 404.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A method of scoring real properties, comprising:
providing a database of real property identities and weightage values for groups, categories and features of the real property identities;
receiving a request by a server computer communicatively connected to the database, from an app of a user computer via a digital data network communicatively connected to the server computer;
retrieving real property identities and weightage values responsive to the request by the server computer;
calculating by the server computer a respective score for each of the real property identities and weightage values from retrieving; and
communicating the respective score for each of the real property identities and weightage values, to the app of the user computer over the digital data network.

2. The method of claim 1, wherein the weightage values correspond to personality types of dominant, compliant, influencing, and steady.

3. A method of scoring real properties, comprising:
storing an app program in a computer communicatively connected to a digital data network;
processing the app program by the computer;
receiving an input to the computer representing a request for real property identities and scores for the real property identities;
communicating the input by the computer over the digital data network to a server computer;
receiving a response from the server computer over the digital data network, by the computer, the response includes real property identities and score for each of the real property identities; and
displaying the real property identities and scores in a display of the computer.

4. The method of claim 3, wherein the scores include measures for personality types of dominant, compliant, influencing, and steady.

5. A system operable via communications over a digital data network, comprising:
a user computer communicatively connected to the digital data network, the user computer includes a processor, memory, and an input device;
an app program of the user computer stored in the memory for controlling the processor;
a server computer communicatively connected to the digital data network; and
a database of real property identities and weightage values communicatively connected to the server computer;
wherein the app program receives an input and communicates the input to the server computer, the server computer searches the database and calculates a respective score for each of the real property identities corresponding to the input, sends to the computer the real property identities and each of the respective score.

6. The system of claim 5, further comprising:
a display of the user computer;
wherein the real property identities and each of the respective score are received by the app program and output by the app program in the display of the user computer.

7. The system of claim 6, wherein the weightage values of the database relate to personality types of dominant, compliant, influencing and steady.

8. A system, comprising:
a processor;
memory communicatively connected to the processor;
wherein the memory contains instructions for controlling the processor for:
communicating over a digital data network communicatively connected to the processor;
processing an input interface output by the processor;
receiving an input to the input interface representing a request for real property identities and scores for the real property identities;
communicating the input by the processor over the digital data network to a server computer;
receiving a response over the digital data network, by the processor, the response includes real property identities and score for each of the real property identities; and
outputting the real property identities and scores by the processor.

9. The system of claim 8, further comprising:
a display communicatively connected to the processor;
wherein the memory includes instructions for outputting the real property identities and scores in the display.

10. A system, comprising:
a processor;
memory communicatively connected to the processor;
a database of real property identities and weightage values for groups, categories and features, communicatively connected to the processor;
wherein the memory includes instructions for controlling the processor for:
receiving a request over a digital data network communicatively connected to the processor;
retrieving from the database real property identities and weightage values responsive to the request;
calculating a respective score for each of the real property identities and weightage values; and
communicating the respective score for each of the real property identities and weightage values, over the digital data network.

11. The system of claim 10, wherein the weightage values of the database relate to personality types of dominant, compliant, influencing and steady.
